(19) United States
(12) Patent Application Publication
(10) Pub. No.: US 2021/0085124 A1
(43) Pub. Date: Mar. 25, 2021

(54) COFFEE MACHINE, IN PARTICULAR FILTER COFFEE MACHINE

(71) Applicant: MELITTA PROFESSIONAL COFFEE SOLUTIONS GMBH & CO. KG, Minden (DE)

(72) Inventors: Bernd BUCHHOLZ, Rahden (DE); Kai HALLMANN, Minden (DE); Jens SCHMALKUCHE, Porta Westfalica (DE)

(73) Assignee: MELITTA PROFESSIONAL COFFEE SOLUTIONS GMBH & CO. KG, Minden (DE)

(21) Appl. No.: 17/040,969

(22) PCT Filed: Apr. 11, 2019
(86) PCT No.: PCT/EP2019/059277

§ 371 Date: Sep. 23, 2020

(30) Foreign Application Priority Data
Apr. 17, 2018 (DE) 20 2018 102 091.9
May 23, 2018 (DE) 20 2018 102 872.3

(51) Int. Cl. A47J 31/46; A47J 31/10; A47J 31/52; A47J 31/00; A47J 31/60

(52) U.S. Cl. CPC A47J 31/468; A47J 31/10; A47J 31/467; A47J 31/461; A47J 31/007; A47J 31/60; A47J 31/52

(57) ABSTRACT

A machine for preparing a hot beverage, comprising: a boiler for producing hotwater; a brewing unit installed downstream of the boiler; and at least one collection vessel installed downstream of the brewing unit, from which collection vessel a prepared hot beverage can be conducted, in particular through an outlet conduit, to at least one dispensing device in order to dispense the hot beverage when the dispensing device is opened. At least one liquid pump is adapted for conveying liquid from the at least one collection vessel towards the at least one dispensing device and for conveying liquid in the opposite direction.

### CROSS-REFERENCE TO RELATED APPLICATIONS

This application is a United States National Stage Application of International Application No. PCT/EP2019/059277 filed Apr. 11, 2019, claiming priority from German Patent Application No. 20 2018 102 091.9 filed Apr. 17, 2018 and from German Patent Application No. 20 2018 102 872.3 filed May 23, 2018.

### BACKGROUND OF THE INVENTION

The present invention relates to a coffee machine, in particular a filter coffee machine, for preparing a caffeinated hot beverage comprising: a boiler for producing hot, in particular boiling, water and having a brewing unit installed downstream of the boiler, which is preferably a coffee filter unit, and having at least one collection vessel installed downstream of the brewing unit, from which a prepared caffeinated hot beverage can be conducted in particular through an outlet conduit to at least one dispensing device in order to dispense it when the dispensing device is opened.

Such coffee machines, especially filter coffee machines, are known in a large variety of embodiments.

### SUMMARY OF THE INVENTION

Against this background, it is an object of the invention to optimize the output of the coffee in order to be able to break new ground in the design of coffee machines, in particular filter coffee machines, of the generic type described above.

The present invention solves this problem by means of a coffee machine, in particular a filter coffee machine, including a boiler for producing hot water and having at least one brewing unit installed downstream of the boiler, which can preferably be a coffee filter unit, as well as having at least one or more collection vessel(s) installed downstream of the brewing unit, in particular heat-collection vessel(s), from which a prepared caffeinated hot beverage can be conducted through at least one outlet conduit to at least one dispensing device, in order to dispense the beverage into a container such as a cup when the at least one dispensing device is opened, and at least one or more liquid pump(s) for conveying liquid, in particular the caffeinated hot beverage, from the at least one collection vessel in the direction of the at least one dispensing device and/or for conveying liquid in the opposite direction, in particular back into the at least one collection vessel.

The invention makes it possible to break new ground in the design of a coffee machine, in particular a filter coffee machine, especially preferably a fully automatic coffee filter machine, for example because the at least one outlet can also be positioned higher than was possible according to the prior art.

A major disadvantage of the prior art without the liquid pump to convey the coffee to the outlet was that it was mandatory to have a slope from the collection vessel to the outlet. This inevitably resulted in restrictions in the height of the beverage container in relation to the dispensing height. This problem is solved by the invention in a simple and cost-effective way.

However, the invention also offers the opportunity to eliminate further disadvantages of the prior art. According to the prior art, the dispensing speed of the coffee beverage was continuously reduced by the free outlet when the fill level in the collection vessel fell. According to the invention, this problem can also be remedied or eliminated if the delivery rate of the liquid pump can be set to a constant level.

In one embodiment the at least one or more liquid pump(s) can be controlled by a control device. The respective liquid pump may be a gear pump, generally a low-cost and easily and precisely controllable gear pump, according to a further embodiment of the invention. The gear pump may be controlled via the control device with regard to its delivery parameters, for example by influencing the speed, and can in particular be controlled in both directions.

An advantage of the invention is that a constant volume dosage can be controlled independently of the filling level of the warmer.

According to an embodiment, the at least one liquid pump is connected directly into the at least one outlet conduit between the at least one collecting vessel and the at least one dispensing device.

In another embodiment, a filter device, such as a filter screen, may be connected upstream of the liquid pump to protect the liquid pump from contamination. In this case, it can also be provided that the filter screen is cleaned by backwashing with the liquid pump via an output device, in particular cyclically into a drain.

It may be particularly advantageously provided that the respective fluid pump is designed and controllable for pumping in two directions.

This is because it can be provided so that water and/or cleaning fluid can be easily pumped back from the respective collection vessel and the respective brewing unit, in particular the coffee filter, using the respective fluid pump in order to clean these units.

In addition, the filter screen in the brewing unit can be rinsed and cleaned from below using liquid.

It is also conceivable that the product output is carried out by a jet control as a dispensing device (aerator).

The term ‘caffeinated hot beverage’ for the purposes of the present invention relates to a coffee beverage, in particular a filtered coffee, and other hot beverages containing caffeine such as tea.

### BRIEF DESCRIPTION OF THE INVENTION

In the following, the invention is explained in more detail in several embodiment variants on the basis of the enclosed figures, wherein the invention is not limited to the concretely represented embodiment variants, wherein:

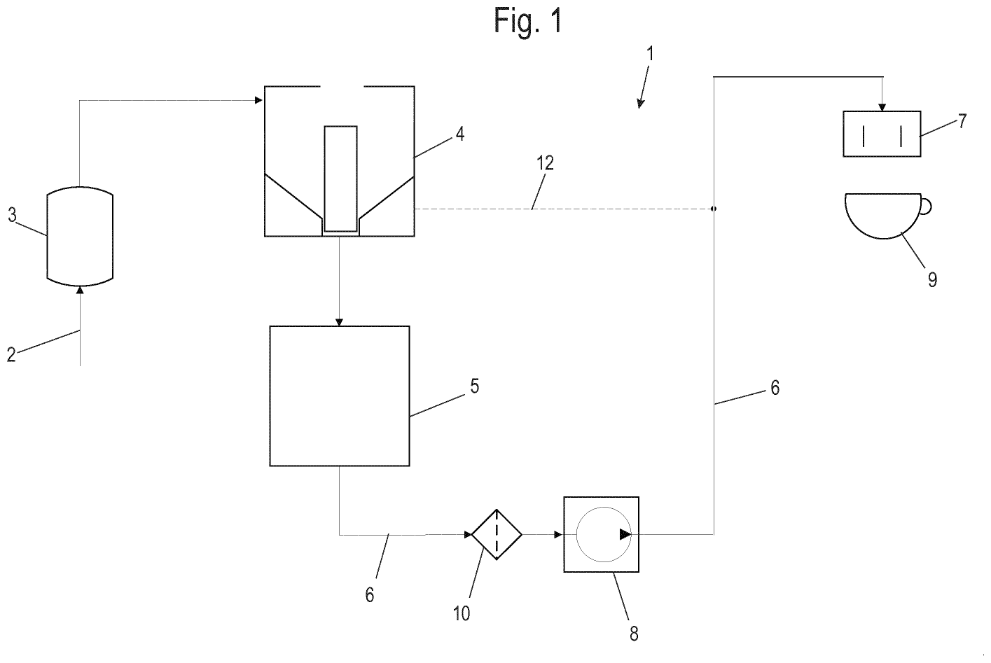

FIG. 1 shows a schematic representation of a first embodiment of a coffee filter machine according to the invention;

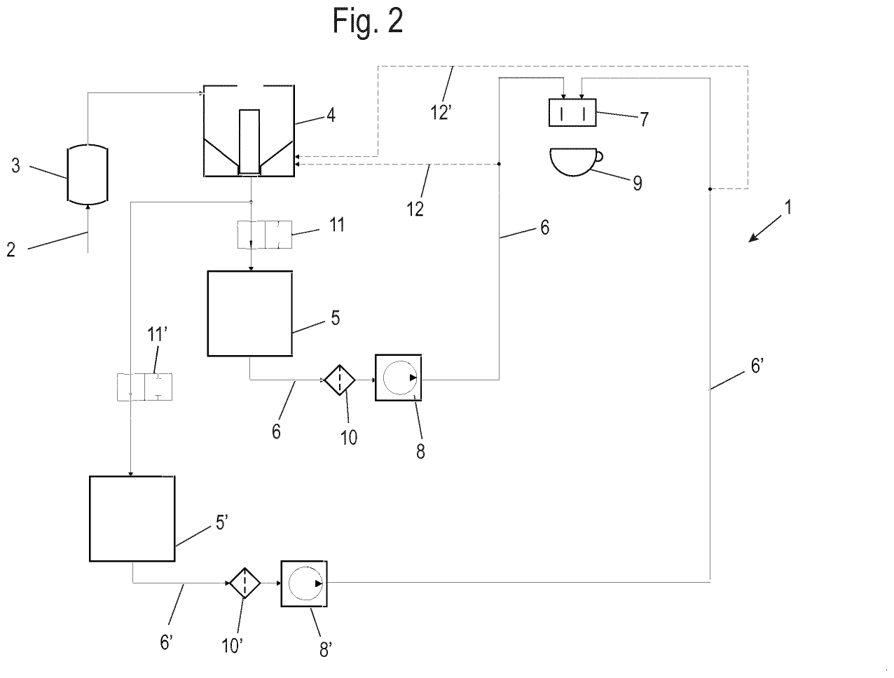

FIG. 2 shows a schematic representation of a second embodiment of a coffee filter machine according to the invention; and

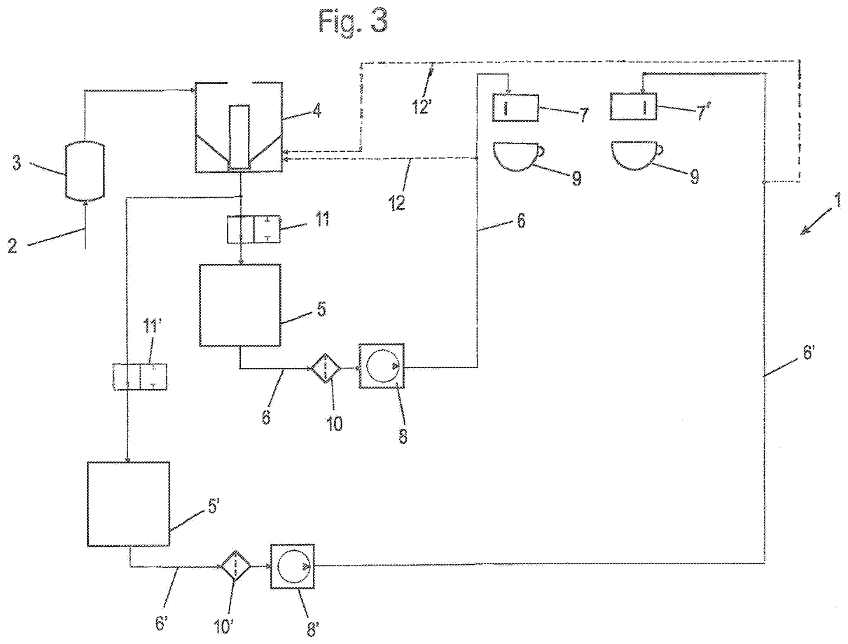

FIG. 3 shows a schematic representation of a third embodiment of a coffee filter machine according to the invention

### DETAILED DESCRIPTION

FIGS. 1 and 2 show first and second embodiments of a coffee machines 1, which can each be designed in particular as a filter coffee machine and particularly advantageously as a fully automatic filter coffee machine.

The respective coffee machine 1, 1′ has a water supply line 2, which can be connected, for example, to a conventional water tap, a house conduit or the like.

The water supply line 2 flows into a boiler 3, which is used to produce hot, especially boiling water.

The water heated by the boiler 3 of FIG. 1 or 2 can be fed from the latter directly or via intermediate devices not shown here, preferably essentially pressureless, into a brewing unit such as a coffee filter 4, wherein the latter can be filled with ground coffee and water to prepare a caffeinated hot beverage such as coffee. The coffee filter can be designed as a metal filter. It can also be designed to be filled automatically and cleaned automatically after the preparation of a coffee.

Referring more particularly to FIG. 1, from the brewing unit, in this case the coffee filter 4, the filtered coffee flows into at least one single collection vessel 5, in particular a warming container 5, as shown in FIG. 1.

From the collection vessel 5, the coffee can flow through an outlet conduit 6 to a dispenser 7, which can be a freely closable outlet. When this dispensing device 7 is opened, the prepared coffee flows into a container like a cup 9.

A liquid pump 8 is interconnected in the outlet conduit 6 between the collection vessel 5 and at least one dispensing device 7.

This liquid pump 8 has the advantage that it can be used to convey the prepared caffeinated hot beverage with additional pressure, so that the dispensing device 7 can be mounted at a greater height than was the case with the prior art, in which the position of the collection vessel 5 determined the possible height of the dispensing device. It is also possible to convey the coffee through other devices not shown here.

This, in turn, makes it possible to break new ground in the design of a filter coffee machine, for example, because the at least one dispensing device 7 can be positioned higher than was possible according to the prior art, for example also significantly higher than the point at which the outlet conduit 6 is or will be led out of the collection vessel 5.

This is also advantageous if more than one collection vessel 5 is provided, for example two warming containers (5, 5′) which are filled alternately, as shown in FIG. 2. In this case, they can also be easily arranged at different heights, for example. The liquid pumps 8, 8′ are then preferably provided in the main flow direction of the coffee behind a point where the outlet conduits 6, 6′ from these two containers are joined together in front of the dispensing device 7.

Optionally, a filter device 10 connected upstream of the liquid pump 8 can be provided to protect the liquid pump 8 from contamination in the same way as a filter screen.

It may also be optionally provided that two or more of the output devices are provided which may be at the same or different heights.

It may optionally also be provided that two or more of the liquid pumps are provided. Such an embodiment is shown in FIG. 2. In this case, various designs are possible. It is thus conceivable, for example, to connect two conduit paths after the only one brewing unit 4, each of which can have a collection vessel 5, 5′ and an outlet conduit 6, 6′. Separate dispensing devices 7, 7′ can be assigned to each of the outlet conduits 6, 6′, as shown in FIG. 3, or it can be provided that the two outlet conduits lead to the same dispensing device 7, as in FIG. 2. In this way, a wide variety of variants can be implemented, which allow adaptation to a wide range of specifications and customer requirements. Thus, the two collection vessels 5, 5′ can be arranged next to each other or vertically above each other. The two liquid pumps 8, 8′ thus allow a wide variety of designs in a simple manner, independent of the arrangement of the dispensing device(s). Both liquid pumps 8, 8′ then offer the advantage that the caffeinated hot drink can be pumped with additional pressure, so that the dispenser(s) can be installed at a greater height than was the case with the current prior art. This in turn makes it possible to break new ground in the design of a filter coffee machine, for example, because the at least one dispensing device 7 can be positioned higher than was possible according to the prior art, for example also significantly higher than the point at which the outlet conduit 6 is led out of the collection vessel 5.

As an option, it can again be provided that a filter device 10, 10′ connected upstream of the respective liquid pump 8, 8′ protects each liquid pump from contamination like a filter screen.

It is advisable to connect respectively controllable valves 11, 11′, in particular shut-off valves, between the brewing unit, in this case the coffee filter 4, and the two collection vessel(s) 5, 5′, i.e., before the respective collection vessel(s) 5, 5′. In this way, in conjunction with the control unit, it is easy to control which of the two collection vessels 5, 5′ is to be filled with the coffee prepared from the one brewing unit 4 or one of several brewing units 4. This filling can, for example, take place depending on various parameters, such as the fill level and/or the time elapsed since the last filling.

Flushing processes and the like can be initiated through conduits 12, 12′ between the outlet conduits 6, 6′, shown here as dashed lines, which can be used alternatively through controllable directional valves not shown here and which are led back into brewing unit 4. The liquid pump(s) have a very beneficial effect(s) here.

1. A coffee filter machine for preparing a caffeinated-hot coffee beverage, comprising:
a boiler for producing hot water;
a brewing unit comprising a coffee filter unit installed downstream of the boiler for preparing the hot coffee beverage;
at least one collection vessel installed downstream of the brewing unit and arranged for receiving from the brewing unit a prepared caffeinated hot beverage;
at least one dispensing device disposed down stream of the at least one collection vessel and being openable and closeable;
at least one outlet conduit coupled respectively between the at least one collection vessel and the at least one dispensing device, wherein the at least one dispensing device is openable to dispenses the prepared hot coffee beverage; and
at least one liquid pump adapted for conveying liquid in a first direction from the at least one collection vessel to the at least one dispensing device and for conveying liquid in a second direction opposite to the first direction.

2. The coffee filter machine according to claim 1, wherein the at least one liquid pump is controllable by a control device.

3. The coffee filter machine according to claim 1, wherein the at least one liquid pump is installed in the at least one outlet conduit between the at least one collection vessel and the at least one dispensing device.

4. The coffee filter machine according to claim 1, wherein the at least one collection vessel includes at least two collection vessels installed downstream of the brewing unit, the at least one outlet conduit includes at least two outlet conduits each coupled between a respective one of the at least two collection vessels and the at least one dispensing device, and the at least one liquid pump includes at least two liquid pumps each installed in a respective one of the at least two outlet conduits.

5. The coffee filter machine according to claim 1, wherein the at least one liquid pump comprises a gear pump.

6. The coffee filter machine according to claim 2, wherein the at least one liquid pump is controllable for delivery of liquid in one or the other of the first and second directions.

7. The coffee filter machine according to claim 1, further including a filter device associated with the at least one liquid pump connected between the at least one collection vessel and the at least one liquid pump.

8. The coffee filter machine according to claim 1, wherein the brewing unit includes at least one brewing unit, and one of water and a cleaning liquid is conveyable back through the at least one collection vessel and the at least one brewing unit by the at least one liquid pump to clean the at least one brewing unit and the at least one collection vessel.

9. The coffee filter machine according to claim 1, wherein the at least one dispensing device is arranged higher than a point at which the at least one outlet conduit is led out of the at least one collection vessel.

10. The coffee filter machine according to claim 1, wherein the at least one dispensing device is arranged higher than one collection vessel of the at least one collection vessel or higher than a plurality of collection vessels of the at least one collection vessel.

11. The coffee filter machine according to claim 1, wherein the at least one collection vessel comprises two collection vessels.

12. The coffee filter machine according to claim 1, wherein the at least one dispensing device comprises two dispensing devices.

13. The coffee filter machine according to claim 1, wherein the at least one liquid pump comprises two liquid pumps.

14. The coffee filter machine according to claim 1, further including a separate controllable valve installed between the brewing unit and and each of the at least one collection vessel.

15. A machine for preparing a hot beverage comprising:
a boiler for producing hot water;
a brewing unit installed downstream of the boiler for preparing the hot beverage;
a collection vessel installed downstream of the brewing unit to which a prepared hot beverage can be conducted;
a dispensing device being openable and closeable and disposed downstream of the collection vessel;
an outlet conduit coupled between the collection vessel and the dispensing device, wherein the at least one dispensing device is openable to dispenses the prepared hot coffee beverage; and
a controllable liquid pump adapted for conveying the hot beverage from the collection vessel in one of a first direction toward the at least one dispensing device and for conveying liquid in a second direction opposite to the first direction.

16. The machine according to claim 15, wherein the liquid pump is controllable by a control device.

17. The filter machine according to claim 15, wherein the liquid pump is installed in the outlet conduit between the collection vessel and the dispensing device.

18. The filter machine according to claim 1, further including a filter device associated with the liquid pump connected between the collection vessel and the liquid pump.

19. The filter machine according claim 1, further including a controllable valve installed between the brewing unit and and the collection vessel.

20. The filter machine according to claim 1, wherein the dispensing device is arranged higher than a point at which the outlet conduit is led out of the collection vessel.
